(19) United States
(12) Patent Application Publication
(10) Pub. No.: US 2024/0320647 A1
(43) Pub. Date: Sep. 26, 2024

(54) AUTOMATED PAYMENT SYSTEM AND METHOD

(71) Applicant: GIESECKE+DEVRIENT CURRENCY TECHNOLOGY GMBH, München (DE)

(72) Inventors: Philipp EDLER, Munchen (DE); Tilo FRITZHANNS, Munchen (DE)

(21) Appl. No.: 18/578,230

(22) PCT Filed: Jun. 13, 2022
(86) PCT No.: PCT/EP2022/025275

§ 371 Date: Jan. 10, 2024

(30) Foreign Application Priority Data
Jul. 15, 2021 (DE) 10 2021 003 664.6

(51) Int. Cl. G06Q 20/20; G06Q 20/32

(52) U.S. Cl. CPC G06Q 20/20; G06Q 20/3278

(57) ABSTRACT

An automated payment method for a payment from a customer to a seller for a sequence of multiple purchase transactions, includes: a) checking in the customer for the sequence of multiple purchase trans-actions, b) receiving items of billing data for each of the purchase transactions, c) checking out the customer for the sequence of purchase transactions; d) adding up the purchase revenues, and e) generating payment data from the added-up purchase revenues and from payment service provider data of the customer. In step c), the checking-out of the customer triggers at least step e), and the customer is checked out depending on previously stored seller-specific and/or customer-specific checking-out base data. The checking-out is performed automatically by determining in advance a checking-out time at which the checking-out will be performed.

The invention relates to an automated payment system and method, preferably using a mobile terminal of a customer.

The process of paying in restaurants has not changed significantly in the recent past. Guests enter a restaurant, where they are not usually known, and order and consume meals and/or beverages. At the end, after they have irreversibly consumed all products, they receive the bill and settle it, in many cultures usually together with a voluntary gratuity. Cash payment, credit or debit card payment can be used—including payment methods using a mobile phone. In rarer cases, payment is made by bank transfer, for example, if a larger group has been entertained for a party, and the invoice is presented and paid later, or if the restaurateur does not use the electronic payment methods for cost reasons. These payment processes are established, accepted worldwide and differ only slightly from country to country and culture to culture.

Nevertheless, there are disadvantages that are generally perceived to be inconvenient, as follows:

Settling the bill requires a multi-step process involving the restaurant staff (indicate a payment request to the waiter, receive bill for review, select payment method, settle bill).

The payment process can take an undesirably long time, depending on the restaurant's service capacity and workload, and the customer cannot leave the restaurant during this time, which often leads to annoyance or even disputes. Also, the table where the guest is waiting for payment is blocked for an unnecessarily long time. There is established law that governs the appropriate procedure if no waiter appears to take payment within an acceptable time.

If a guest wants to treat other guests, a somewhat awkward situation often occurs when paying the bill. Spending an evening with invited guests is often a motivation for visiting a restaurant. The person paying the bill will try to complete the payment process as discreetly as possible with the waiter, and the guests being treated will look away discreetly if necessary. To avoid this, the person paying often tries to find a convenient moment to pay the bill away from the table, unnoticed by the other guests.

If multiple guests split the bill, the payment process takes a long time and can lead to confusion. Often, guests at a table want separate bills that reflect their individual consumption. In this case, the waiter must separate the bill according to guests, collect the payments separately and ensure that all items are covered. This is a very cumbersome and therefore lengthy process and often leads to confusion, especially when there are items left at the end that then have to be settled retrospectively.

EP 2081140 A1 and EP 2592584 A1 relate to the securing of wireless payment transactions carried out using a mobile device, for example a cellular radio device, as well as stationary position transmitters, for example RFID or NFC tags. WO 2014/105226 A1 discloses a system in which a customer can automatically log in to process contactless payment procedures in a department store, in which stationary tags are also used. A refinement of this system is described in WO 2015/034755. WO 2016/053975 A1 also discloses a contactless payment method with which a user can enable a payment, requested by a seller, by means of a terminal device, for example a mobile phone. In all cases the cooperation of the customer is required.

The ideal scenario for a restaurant visit is one in which unpleasant processes are eliminated. These include payment processes that involve the guest. The inclusion of mobile phones and radio communication with databases (see above) does not solve this problem. The same applies to purchases that consist of multiple individual purchases.

The object of the invention is therefore to simplify the payment process in a sequence of multiple purchase transactions, e.g. taking orders in a restaurant, in particular when a mobile device and radio communication is used.

The invention is defined in the independent claims. The dependent claims relate to advantageous refinements.

It is intended to provide an automated payment method for a customer to make a payment to a seller for a sequence of multiple purchase transactions. To this end, the following steps are performed in a sales unit, e.g. a seller's computer:
a) checking in the customer for the sequence of multiple purchase transactions;
b) receiving items of billing data for each of the purchase transactions, each item comprising a purchase revenue of the purchase transaction,
c) checking out the customer for the sequence of purchase transactions;
d) adding up the purchase revenues, and
e) generating payment data from the added-up purchase revenues and from payment service provider data of the customer,
wherein in step c) the checking-out of the customer triggers at least step e), and
wherein in step c) the customer is checked out automatically depending on seller-specific and/or customer-specific checking-out base data.

The checking-out is performed automatically by determining a checking-out time at which the checking-out will be performed on the basis of the checking-out base data and/or by checking the plausibility of the accounting data on the basis of the checking-out base data as a checking-out criterion.

The checking-out is therefore preferably only carried out when the determined checking-out time has been reached and/or the checking-out criterion, namely plausibility of the billing data of the sequence of purchase transactions, has been met. The reaching of the previously determined checking-out time is monitored and can trigger the checking-out step, in particular if the received billing data is also found to be plausible.

The checking-out time can be determined on the basis of the checking-out base data and the billing data. The automatic checking-out time is thus determined, on the one hand, individually for the customer and/or the seller, but on the other hand, independently of an actual, if necessary manual, active checking-out by the customer or seller.

In particular, the checking-out is only carried out automatically if the checking-out time has been reached and/or the checking-out criterion has been met. If, on the other hand, neither the checking-out time has been reached nor is the checking-out criterion met, or alternatively, either the checking-out time has not been reached or the checking-out criterion is not met, the customer is not automatically checked out.

The plausibility of the billing data of the sequence of purchase transactions can be checked as soon as the determined checking-out time is reached. Alternatively or in addition, the plausibility of the billing data is checked as soon as billing data of a purchase transaction is received. In particular, the checking-out can take place in this case if it is identified on the basis of the checking-out base data that a sequence of purchase transactions with plausible billing data is present that triggers the checking-out.

The automated method checks the customer, e.g. in the form of data via their mobile device, into the seller software for multiple purchase transactions. This represents a check-in.

The customer-specific and/or vendor-specific checking-out base data items are of course already stored before the check-in step. They can be provided to the sales unit or the seller software that runs on the seller unit or can be accessed on a server.

In addition, payment service provider data for the customer is or will be stored, e.g. by transfer from the mobile device to the seller software. This may well have happened in advance (subscription).

Purchase transactions are then performed repeatedly. For each purchase transaction, billing data comprising purchase revenues of the respective purchase transaction is generated in the seller software. The billing data can comprise billing objects (e.g. products/services ordered), prices of the billing objects, ordering times, etc. The data is checked for plausibility based on predetermined criteria and an expected completion time of the sequence of purchase transactions is determined, preferably also on the basis of the billing data. In particular, only the purchase revenues from the accounting data for which the plausibility check was successful are accepted and added to the total. Once the expected completion time has been reached, debit data is generated from the cumulative purchase transactions and the payment service provider data automatically, i.e. without necessarily requiring the cooperation of the customer, and payment is thus made for all purchase transactions taken into account. At the same time, the customer or their mobile device is checked out from the vendor software.

The automated payment system comprises the identification unit of the customer, in particular the mobile device on which an executable piece of customer software and, if applicable, the payment service provider data are stored, the seller computer on which the executable seller software is stored or from which the seller software running on a server can be accessed, and which has an interface for transferring payment data to a payment service provider. The customer software and the seller software are designed, when executed on the terminal device or the seller computer or server, to carry out the above method.

By means of the system or method according to the invention a guest can visit a restaurant, order, eat and drink and then leave right away. The payment process takes place completely automatically in the background. Nevertheless, the customer preferably receives an electronic bill for the services and payments they purchased, which they can view and check either during or after the visit. Ideally, this is not at all necessary, as errors are largely proactively excluded by the system.

The system/method has completely pushed the payment process into the background. Only the gratuity may require interaction. Depending on the customer's security needs, in rare cases security interaction may be required, but this can also (given an appropriate level of trust) be left to the restaurant for resolution.

The system/method simplifies the payment process, in particular by means of a high degree of automation. This essentially shifts the risk of the business process away from the provider onto the customer. Previously the entire risk fell upon the provider, as they could only check the creditworthiness of the customer once the final payment was made. This is particularly problematic in the catering industry when diners leave without paying. By means of the invention, the customer already gives their consent to payment in this restaurant in the technically assisted check-in process. To protect the customer against incorrect charges, safeguarding measures are provided.

These include a plausibility check of the order/delivery and a prediction of a check-out time for a timed, automatic check-out.

### Plausibility Check

After the customer has checked in at their table, each order is checked for plausibility. This protects the customer against incorrect charges. Predetermined criteria are used for this purpose. For example, ordering a main course after a dessert has already been ordered, or ordering new drinks only a few minutes after drinks have already been ordered for all guests, would be implausible and rejected by the system/in the method. Criteria can also be applied that the system has learned from the individual customers—e.g. customer does not drink alcohol, is vegetarian, does not have dessert, etc. Orders that were filtered out in the plausibility check would result in a warning notification and require separate acknowledgment by the server and/or guest.

The plausibility check can be based on fixed rules or can also be learned automatically by the system based on individual consumer behavior. A combination of both approaches may also be used. These self-learning algorithms can be based, for example, on multivariate classifiers with Bayesian estimates to estimate the probability of the correctness of an order. Such algorithms are known to a person skilled in the art, e.g. from recommendation systems: “Customers who bought item A are also interested in item B.” However, the logic here is reversed: “Customers who have ordered product A typically do not order product B.”

### Prediction of the Check-Out Time

When the guest leaves the restaurant, they should be automatically checked out so that no further charges against the customer are possible. This also protects them against incorrect charges, as the waiter cannot assign other orders, e.g. those of the next guest, to the previous guest either intentionally or accidentally. In order to predict the time of the check-out, i.e. to estimate when to expect the end of the sequence of purchase transactions, and hence the end of the customer's visit, customer-independent data (e.g. typical length of stay in the restaurant, time of day, standard ordering procedures) and/or customer-specific data (e.g. which products have been ordered so far, customer history) are preferably used. On the basis of this data, a model, in particular based on machine learning, is preferably used to estimate an expected time when the guest will have left the restaurant, i.e. the sequence of multiple purchase transactions will be completed. For example, after a guest has ordered a dessert and possibly coffee, the expected time of check-out will not be far away, while after ordering an aperitif, the guest is likely to spend longer in the restaurant. The same applies to purchases in a non-restaurant environment. Once the expected time is reached, the guest is automatically checked out.

It is advantageous here that the prediction does not need to be too precise, as the estimated time should be between the last order and shortly after the departure of the guest. If the estimate is incorrect, the guest can be manually checked out or checked in again. This requires an optional confirmation by the guest to prevent an incorrect or even fraudulent re-check-in of a properly checked out guest.

Preferably, a re-check-in is logged, which in case of doubt would not cause the entire bill to be disputed, but only the part starting from the new check-in.

In embodiments, a period of time is calculated from the data, after which no further order is expected or the probability of a further order drops below a threshold value. For this purpose, classification trees or regression methods can be used. If another order is received within this predicted time period, the calculation will be updated. Otherwise, the predicted time will be reached when the time period has expired.

In addition, the following optional security mechanisms against fraudulent intent or incorrect charging are available:
1. A local presence is required. It is verified by the presence of the smartphone (e.g. scanning the QR code, contact with a Bluetooth beacon, geolocation of the smartphone). If applicable, the (non-canceled) reservation is sufficient as proof of the customer's presence.
2. A maximum amount can be provided that cannot be exceeded and can only be changed after a security feature has been verified, e.g. by entering a password or checking a biometric feature. The maximum amount can also be determined by the system on a customer-specific basis. The customer him/herself could also pre-authorize an amount X in the system, e.g. at the time of making the reservation. A default amount can also be suggested by the system for the respective restaurant.
3. An option that further enhances security is a “veto period” for each order, which begins as soon as a push message about the order has been sent to the mobile device. Each order will then only be activated and charged after this objection period has expired (e.g. two or three minutes). During this time, the customer can object and cancel the order via their smartphone. Optionally, the veto status of each order can be displayed in the kitchen. The chef can then start the preparation before the end of the period, at their own risk, or wait until it has expired before commencing preparation or delivery. In practice, it is unlikely that the kitchen will begin to prepare an order within two or three minutes of receiving it. Of course, the veto requires the customer to respond to the push message with their smartphone.

The invention achieves a complete relocation of the payment process into the background without requiring a confirmation from the customer at any time, in particular (manual) checking of the bill. However, security mechanisms are introduced to protect the customer from intentional or (much more likely) accidental incorrect charges. The invention provides for the automatic plausibility checking of each order and for predicting the departure from the restaurant (and hence the time of check-out).

The use of a mobile device assigned to the customer is a preferred aspect of both the method and the system, because the automated payment process can be handled particularly simply by means of this mobile device. A prerequisite is that the customer participates in an electronic payment system, such as provided by the provider PayPal, Inc. The seller (in the above examples, the restaurant) also participates in this payment system, which ultimately handles the money transfer. Such a system is, of course, known to a person skilled in the art.

Insofar as the invention is described and explained here with reference to payment in a restaurant, this is purely exemplary. Rather, the invention is directed to all payment transactions in which multiple individual products or services are purchased over an extended period of time in a sequence of purchase transactions and ultimately paid for collectively. Thus, where the term guest is used, this is to be understood only as an example of a customer, and the ordering of food and beverages is merely one example of the multiple purchase of individual goods or services.

“Automatic” in this description means that no approval by a user is requested and/or waited for.

The invention further relates to a method of payment in such an environment. It equally covers a corresponding system consisting of the devices defined in the corresponding system claim. Insofar as the description is explained below with reference to the payment method, this must also not be interpreted as a restriction. Rather, as also explained in the exemplary embodiments, the system can handle the corresponding payment method.

In the following the invention is explained in more detail based on exemplary embodiments and with reference to the attached drawings, which also disclose features essential to the invention. These exemplary embodiments are intended for illustration purposes only and should not be construed as limiting. For example, a description of an exemplary embodiment having a plurality of elements or components is not to be interpreted as meaning that all these elements or components are necessary for the implementation. Rather, other exemplary embodiments may also contain alternate elements and components, fewer elements or components, or additional elements or components. Elements or components of different exemplary embodiments can be combined with one another, unless otherwise specified. Modifications and variations described for one of the exemplary embodiments can also be applied to other exemplary embodiments. To avoid repetition, the same or corresponding elements in different figures are designated with the same reference signs and not explained more than once. In the drawings:

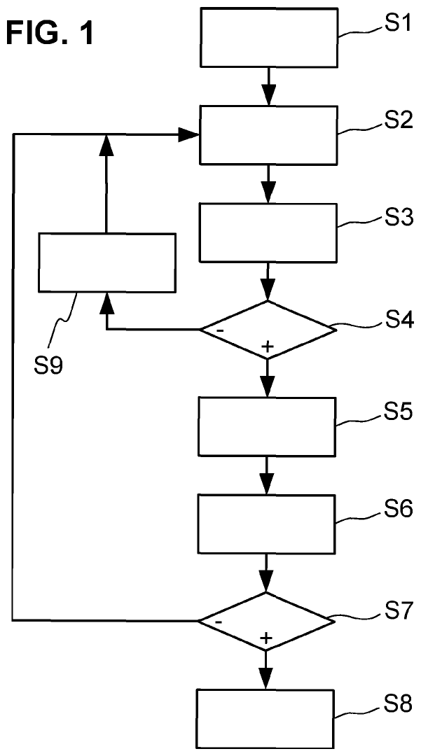

FIG. 1 shows a flowchart of an embodiment of a payment method in a restaurant and

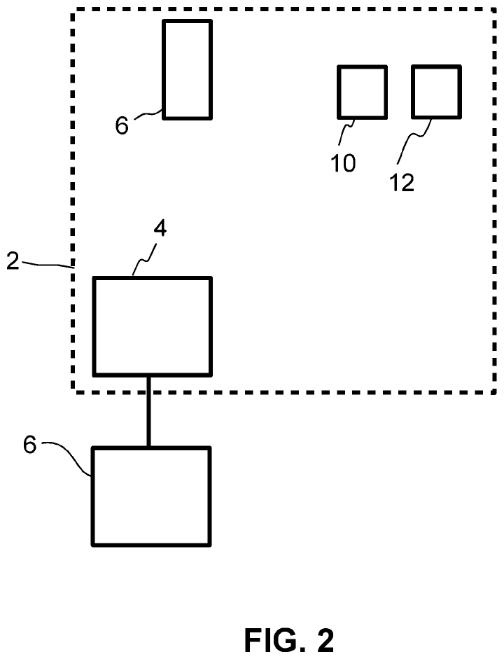

FIG. 2 shows a schematic representation of a system with which the payment method is implemented.

As described above, a payment method is described based on a restaurant visit without this being restricting.

FIG. 1 shows a flow diagram of a first embodiment of a payment method. FIG. 2 shows the associated system components. The guest will register in advance with a payment service provider, with whom the restaurant also works. Furthermore, the customer's device runs an app (software package), which interacts with a computer 4 belonging to the restaurant.

The method consists of three blocks A to C:
A—Check-in: At the beginning, the guest is checked in on the computer 4 of the restaurant (step S1), preferably with the guest's mobile device (alternatively, another means can be used, such as a chip card or a machine-readable code, e.g. a QR code). Due to the check-in, the computer 4 has access to payment service provider data of the guest, e.g. by transmission from the mobile device 8 to the seller's computer 4. Typically, the guest is assigned to a location in the restaurant. If the mobile device is used, messages can be exchanged between computer 4 and device 8.
B—Order/Delivery Phase: The guest then orders and consumes the meal (steps S2-S7).
C—Check-out: Finally, the bill is prepared and settled automatically and the guest leaves the restaurant at about the same time (step S8).

### Check-In (Step S1)

When the guest enters the restaurant 2, they have preferably already reserved a table (e.g. via app/website) and can be checked in at this table by the waiter.

Alternatively, the guest selects a free table and automatically checks him/herself in at this table using a QR code 10 affixed to it or by means of a Bluetooth beacon 12. Due to the inadequate spatial resolution of the beacon 12, however, the table number may need to be recorded separately.

The following check-in sequences are conceivable:

The guest is already reserved for a specific table. The waiter takes the guest to this table and the guest checks him/herself in at the table using QR code 10. This process achieves a high degree of process reliability by comparing the plausibility between reservation and check-in.

The guest checks in with the waiter, e.g. by showing a QR code that individualizes the customer and which is scanned by the waiter in order to complete the registration on the seller's computer 4. Alternatively, the waiter could also show the guest an individual QR code, which the guest uses to check in. In both variants, errors in the table/guest assignment are avoided.

The restaurant books the guest directly onto a table reserved for them. In this case, no participation by the guest is necessary.

The check-in therefore preferably assigns the guest to a table/location in the restaurant. Then the “delivery location” for the food, beverages or goods is automatically defined.

### Ordering/Delivery Phase (Steps S2-S7)

The guest traditionally orders from the waiter (step S2), who logs the food/beverages in the seller's computer 4 for the guest.

In order to avoid incorrect order entries, a plausibility check is optionally provided according to steps S3, S4, which can be based, for example, on intelligent algorithms or models or default specifications and may also use customer-specific data. If in a plausibility check (step S3) the order entered in step S2 appears implausible (step S4, “−” branch), the waiter is notified and must confirm the correctness of the order entry (step S9), otherwise it will be automatically rejected. If necessary, the guest must participate via their mobile device, so that an implausible entry requires explicit confirmation by the customer. Possible methods for this plausibility check will be discussed in greater detail later.

Only if the plausibility check was successful (step S4, “+” branch) is the entry credited to the bill and the guest optionally receives a push message confirming the order on their mobile phone 6, which does not require interaction.

### Check-Out

When the guest has finished eating and drinking, they leave the restaurant and are automatically checked out (steps S7, S8). The invoice is automatically created and settled using the stored payment method. The guest will then receive an optional push message with the option of adding a tip.

The automatic check-out in some embodiments is initiated in a timed manner on the basis of the orders, so that a checking-out time is determined. For each customer the expected time of leaving the restaurant is estimated (step S6)—i.e. as opposed to merely allowing a default time-out period to elapse. This estimate takes into account the previous behavior of the customer and/or other customers. Since the time does not need to be very precise (it should be after the guest's last order and not later than shortly after their leaving the restaurant), the estimation is simpler and mistakes such as too early or too late checkouts are easily avoided. If the selected time was too early, the guest can either be checked in again (by the waiter or the guest him/herself), i.e. the method starts again at step S1. Once the estimated time has been reached (step S7, “+” branch), the guest is automatically checked out and the bill is closed (step S8) and submitted to the payment service provider for payment. In embodiments, the checking-out time is determined on the basis of default specifications, which can be either global (e.g. average length of stay for all customers) or individual to the customer (e.g. average length of stay for the customer concerned).

If the time has not been reached (step S7, “−” branch), the system jumps back to step S2 (further order possible). In step S6, the time of the expected end of the visit is re-estimated or an earlier estimate is updated.

In some embodiments it is possible both for the guest to check him/herself out in the app even after leaving, and for the waiter to check out the guest in the system if they discover that the guest has left.

As an option, during step S8 the customer is asked whether they intend to give a gratuity. Optionally, a gratuity is pre-configured and does not need to be explicitly indicated.

The total amount is then determined in step S8 (i.e. the bill is created) and settled using the stored payment method, i.e. a payment record is generated and transmitted to the payment service provider in order to collect the resulting sum of money.

To implement the method, the customer preferably installs the app on their mobile phone 8 and stores data there for a payment service provider (PayPal, credit card, Instant Payments, . . . ). When the customer enters a venue 2 that supports the app, they are automatically connected to the seller's computer 4 of the venue 2 (check-in) upon opening the app or with the assistance of the waiter. This can take place automatically, e.g. via geolocation, a Bluetooth beacon, the WLAN or via a QR code, which is affixed to every table.

FIG. 2 shows a schematic block diagram of a system for processing the described methods. The system provides a plurality of units arranged in a restaurant 2, which is a concrete example of a sales room. On the one hand, the system comprises the seller's computer 4, into which the waiter enters the customer's orders. The seller's computer 4 is connected via a data connection, not further indicated, to an external central computer 6, which is provided by the payment service provider, for example PayPal, Inc. This central computer is not part of the system—and neither is the restaurant 2. The only important feature is that the seller's computer 4 can transmit debit data in order to request a payment transaction for the amount of the final bill from the central computer 6. This can even be carried out later, i.e. offline, in relation to the guest's stay.

Furthermore, there is at least one mobile phone 8 of a guest in the restaurant 2, which is an example of a mobile device. It also has a connection to the central computer 6, wherein the connection does not necessarily need to be maintained during the payment process. Rather, it is crucial that the guest is registered with the payment service provider and provides the seller's computer 4 with the appropriate data, which it needs to settle the final bill via the payment service provider.

Optionally, the system also comprises the QR code 10 and/or the transponder 12, which allows checking into the restaurant software in step S2 (check-in) more easily or even fully automatically, in particular including assignment of the guest to the respective table.

A software package runs on both the seller's computer 4 and the mobile phone 8, wherein these software packages are designed such that in communication between the seller's computer 4, mobile phone 8 (optionally QR code 10 and/or transponder 12) and central computer 6 in the restaurant 2 the above-described method can be carried out. This software package can also be a server-based web application that does not require installation.

In order to prevent misuse in the event of theft of the smartphone 8, the check-in process (step S2) could be secured using a biometric feature or password. If necessary, maximum values that can be output once per check-in process/per day are preset in the system. Optionally, the maximum value depends on a security level of the appropriately classified check-in method.

### LIST OF REFERENCE SIGNS

2 restaurant
4 seller's computer
6 central computer
8 mobile phone
QR code
12 transponder
S1-S9 steps

1.-16. (canceled)

17. An automated payment method for a payment from a customer to a seller for a sequence of multiple purchase transactions, wherein the following steps are performed in a seller unit:
a) checking in the customer for the sequence of multiple purchase transactions;
b) receiving items of billing data for each of the purchase transactions, each item comprising a purchase revenue of the purchase transaction,
c) checking out the customer for the sequence of purchase transactions;
d) adding up the purchase revenues, and
e) generating payment data from the added-up purchase revenues and from payment service provider data of the customer,
wherein the checking-out of the customer triggers at least the step of generating the payment data, and
the customer is checked out automatically depending on previously stored seller-specific and/or customer-specific checking-out base data, by
determining a checking-out time at which the checking-out will be performed on the basis of the checking-out base data and/or
as a checking-out criterion, checking the plausibility of the billing data on the basis of the checking-out base data.

18. The automated payment method according to claim 17, wherein the checking-out time is determined on the basis of the checking-out base data and the billing data.

19. The automated payment method according to claim 17, wherein the checking-out takes place only when the determined checking-out time is reached and/or the checking-out criterion, plausibility of the billing data of the sequence of the purchase transactions, is met.

20. The automated payment method as claimed in any of the above claim 17,
wherein the plausibility of the billing data of the sequence of purchase transactions is checked as soon as the determined checking-out time is reached, or
the plausibility of the billing data is checked as soon as billing data of a purchase transaction is received, wherein the checking-out is preferably only carried out when a sequence of purchase transactions with plausible accounting data that triggers the checking-out is identified based on the checking-out base data.

21. The automated payment method according to claim 17, wherein the customer is checked in by means of an identification unit of the customer, in particular by means of a mobile device, a chip card and/or a machine-readable code, such as a QR code.

22. The automated payment method according to claim 17, where the following are already stored before the checking-in step:
the previously stored customer-specific and/or seller-specific checking-out base data, and/or
the payment service provider data of the customer.

23. The automated payment method according to claim 17, wherein the previously stored checking-out base data and/or the payment service provider data are provided, in particular retrieved by means of a customer ID, optionally from an external server.

24. The automated payment method according to claim 17, comprising repeatedly carrying out the following sub-steps in step b) for the individual purchase transactions of the sequence
b1) receiving the billing data comprising the purchase revenues of each individual purchase transaction,
b2) ascertaining the checking-out time in the form of an expected completion time for the sequence of purchase transactions on the basis of the billing data.

25. The automated payment method according to claim 17, wherein the plausibility check of the billing data is carried out on the basis of predetermined criteria and in step d) an addition of the purchase revenues from those billing data for which the plausibility check was successful is performed automatically.

26. The automated payment method according to claim 17, wherein the checking-out base data comprises as seller-specific data a typical length of stay in a sales outlet in which the sequence of the multiple purchase transactions is performed, and/or standard ordering procedures, and/or as customer-specific data, a history of products already purchased, a history of past purchase transactions, and/or a number of people associated with the billing data.

27. The automated payment method according to claim 17, wherein to determine the checking-out time on the basis of the billing data, a period of time is calculated after which no further purchase transaction is expected or the probability of a further purchase transaction falls below a predetermined threshold value.

28. The automated payment method according to claim 17, wherein the checking-out time is updated after each purchase transaction.

29. The automated payment method according to claim 17, wherein the checking-out base data is determined using machine learning methods, such as a classification tree or a regression method.

30. The automated payment method according to claim 17, wherein an order for an individual purchase transaction is activated and booked only after expiry of an objection period, during which the customer can object and cancel the order using a mobile device.

31. The automated payment method according to claim 17, wherein after each purchase transaction a message which at least partially contains the billing data is sent to at least one mobile device.

32. An automated payment system comprising a mobile identification unit, in particular mobile device, on which an executable piece of customer software can be called up, a seller computer, on which an executable piece of seller software can be called up and which has an interface for transferring payment data to a payment service provider,
wherein the customer soft-ware and the seller software, in particular if they are executed on the mobile device or the seller's computer or a server, are designed for carrying out the method according to claim 17.
